(19) United States
(12) Patent Application Publication
(10) Pub. No.: US 2008/0042556 A1
(43) Pub. Date: Feb. 21, 2008

(54) Organic light emitting structure

(75) Inventors: Ta-Ya Chu, Padeh City (TW); Szu-Yi Chen, Padeh City (TW); Chin-Hsin Chen, Padeh City (TW); Wen-Jian Shen, Padeh City (TW); Shuenn-Jiun Tang, Padeh City (TW); Chan-Ching Chang, Padeh City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD

(21) Appl. No.: 11/591,605

(22) Filed: Nov. 2, 2006

(30) Foreign Application Priority Data
Aug. 18, 2006 (TW) 95130462

(51) Int. Cl. H05B 33/00

(52) U.S. Cl. 313/504

(57) ABSTRACT

An organic light emitting structure employs alkaline-earth metal between a cathode and an electron-transport layer. Such a structure may improve degraded luminescence of light emitting structure and enhance stability of element operation.

### BACKGROUND OF THE INVENTION

1. Field of the Invention

The present invention relates to an organic light emitting and an inverted organic light emitting structures.

2. Background of the Related Art

Active-matrix architectures have been widely adopted in high-performance displays using organic light emitting structure (OLED). Active-matrix OLED displays (AMOLEDs) are generally benefit from adopting top-emitting OLED structure, which remove limitations in the optical transparency of substrates and on the OLED filling factor of pixels. Inverted OLEDs, i.e., making OLEDs that have a reflective cathode at bottom and a (semi-) transparent anode on top, would render feasible use of generally superior n-type transistors rather than p-type transistors in the AMOLED pixel circuitry and further enhance performance.

One major challenge in inverted top-emitting OLEDs, however, is to prepare reflective bottom cathodes all involves handling highly reactive low-work-function metals during fabrication. In one way, they were deposited as the cathode layer directly. However, changing the formation process of the contact leads to the degraded electron-injecting capability. Furthermore, it is not practical for actual display fabrication. In another way, reactive metals and organic electron-transferring materials are disposed simultaneously to form an n-doped layer for facilitating electron injection from the bottom cathode. Yet, there remain issues in diffusion of metal dopants and thus operation reliability.

### SUMMARY OF THE INVENTION

One of objects of the present invention is to provide an organic light emitting structure. A metal layer with low work function is inserted between a cathode and an electron-transport layer to enhance the operating stability of a device.

One of objects of the present invention is to provide an inverted organic light emitting structure. Magnesium is added between a cathode and an n-type doped layer to reduce degraded luminance of a device.

Accordingly, one embodiment of the present invention provides an organic light emitting structure which includes a cathode, an anode, a hole-transport layer between the cathode and the anode, an electron-transport layer between the hole-transport layer and the cathode, and an alkaline-earth metal material is between the cathode and the hole-transport layer.

### BRIEF DESCRIPTION OF THE DRAWINGS

FIG. 1A is a schematically cross-sectional diagram illustrating an inverted organic light emitting structure in accordance with a preferred embodiment of the present invention.

FIG. 1B is a schematically cross-sectional diagram illustrating an organic light emitting structure in accordance with a preferred embodiment of the present invention.

FIG. 2A and FIG. 2B are diagrams illustrating the relation of luminance and current density vs. voltage for the devices with or without an electron-injection layer in accordance with the present invention.

FIG. 3 is a diagram illustrating the structures in FIGS. 2A and 2B with different degraded luminance in accordance with the present invention.

FIG. 4 is a diagram illustrating the structures in FIGS. 2A and 2B with different raised voltages in accordance with the present invention.

### DETAILED DESCRIPTION OF THE INVENTION

As used herein, a “layer” of a given material includes a region of that material whose thickness is small compared to both its length and width. Examples of layers include sheets, foils, films, laminations, coatings, and so forth. As used herein a layer need not be planar, but can be bent, folded or otherwise contoured, for example, to at least partially envelop another component. As used herein a layer can also include multiple sub-layers. A layer can also consist of a collection of discrete portions.

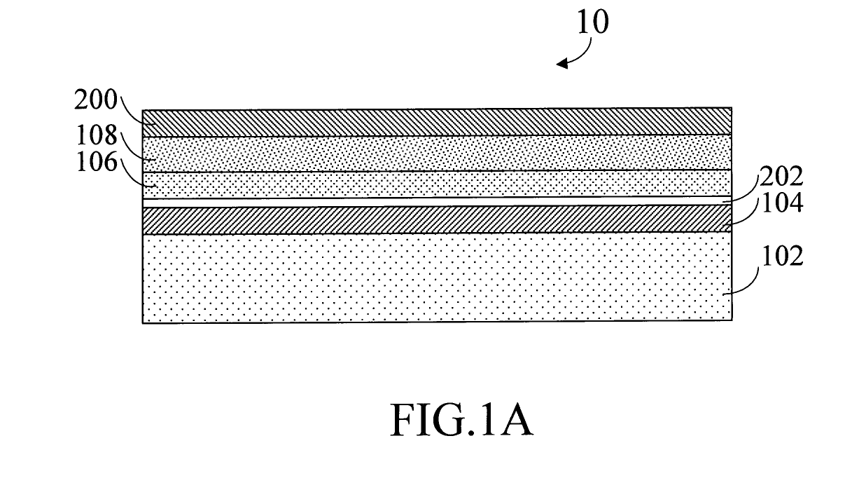

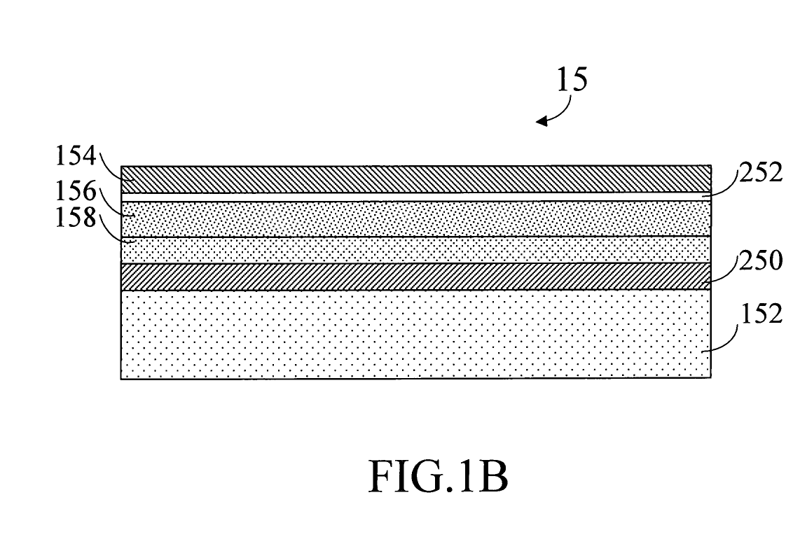

Shown in FIG. 1A, an inverted organic light emitting diode 10 includes a substrate 102, a cathode 104, an electron-transport layer 106, a hole-transport layer 108 and an anode 200. In one embodiment, the substrate 102 may be a glass substrate, a plastic substrate or a flexible substrate. Next, the cathode 104 on the substrate 102 may be transparent, opaque, reflective single layer of composition, such as indium tin oxide (ITO), indium zinc oxide (IZO), Au, Ag, Pt, Ni, Cr, Mo, Cu, Al, Ca or the combination thereof. The anode 200 may be also transparent, opaque, reflective single layer of composition, such as Au, Pt, Li, Mg, Ca, Al or Ag, or ITO, IZO, LiF/Au, Be/Al or Mg/Al.

Next, the electron-transport layer 106 may be capable of transporting electron, such as n-type dopants in an organic material to form an n-type doped layer. On the other hand, the hole-transport layer 108 may be capable of transporting holes, such as p-type dopants in another organic material to form a p-type doped layer. Alternatively, the electron-transport layer 106 may be made of electron-injection, electron-transport, hole-blocking or emitting material or composition, such as Alq3 (tris-(8-hydroxyquinoline aluminum), fluorescence material, or phosphorescence material. The hole-transport layer 108 may be made of hole-injection, hole-transport, or electron-blocking material or composition. According to the spirit of the present invention, alkaline-earth metal material, such as Be, Ma, Ca, Sr, Ba, Ra, is added between the cathode 104 and the electron-transport layer 106, whose low work function may enhance the stability of a device under operation. In a preferred embodiment, an electron-injection layer 202 is formed between the cathode 104 and the electron-transport layer 106 of n-type doped layer. Accordingly, the electron-transport layer 106 and the hole-transport layer 108 are combined to form an active layer for injecting, transporting electron/hole, or emitting or combination of aforementioned function.

Shown in FIG. 1B, an organic light emitting diode 15 includes a substrate 152, an anode 250, a hole-transport layer 158, an electron-transport layer 156 and a cathode 154. A hole-injection layer 252 is positioned between the electron-transport layer 156 and the cathode 154. The layers in the organic light emitting diode 15 are similar to the ones of the inverted organic light emitting diode 10 in FIG. 1A and not illustrated herein. Accordingly, the hole-injection layer 252 may be applied to various organic light emitting diodes.

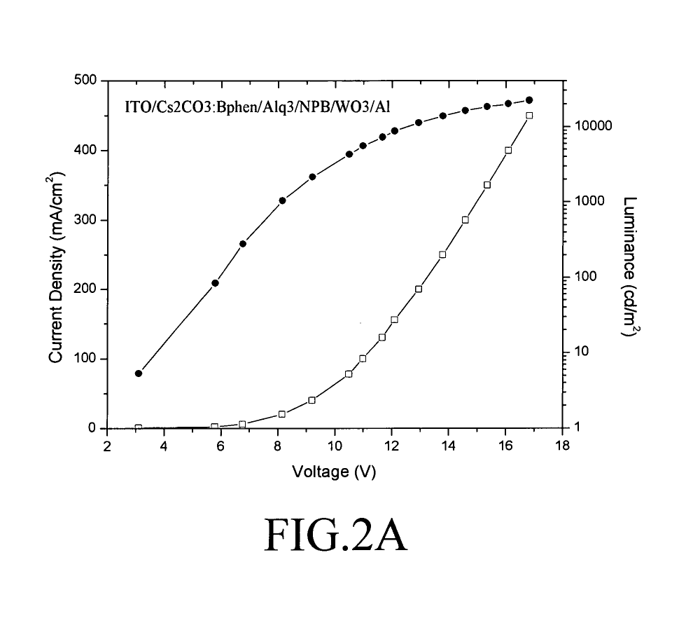

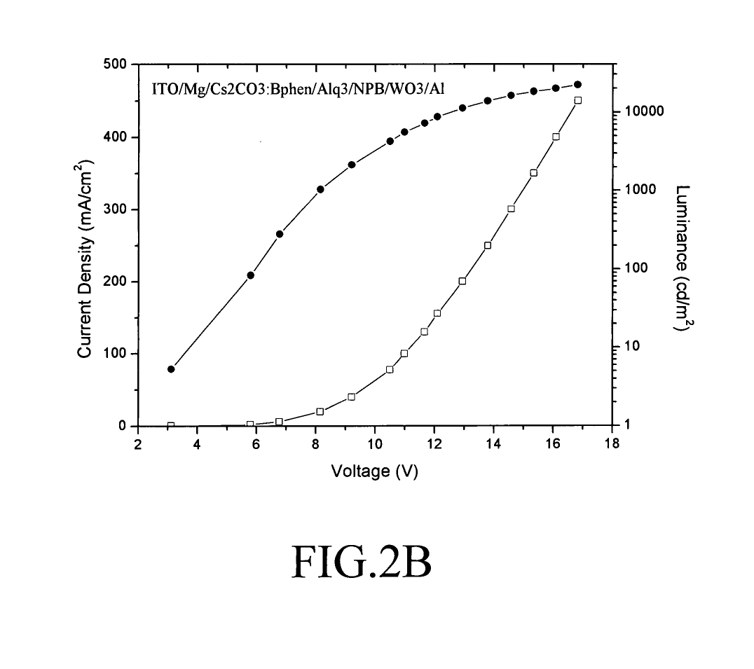

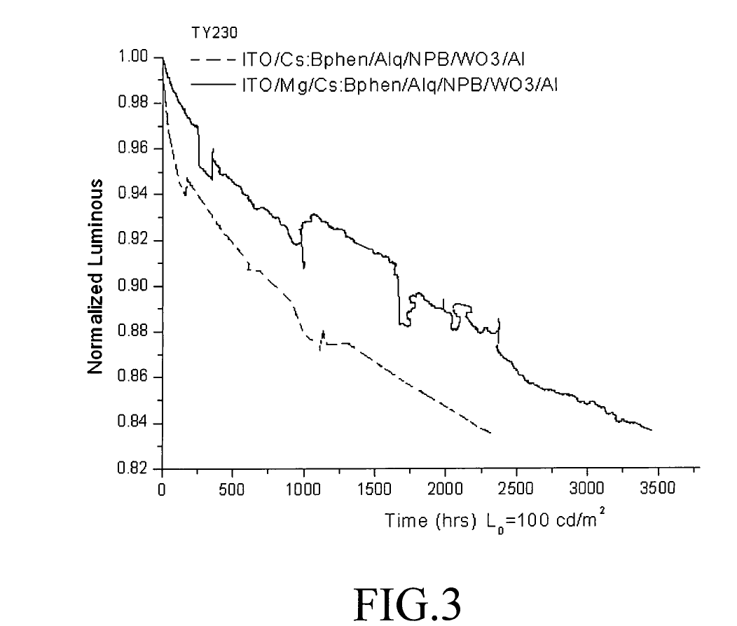

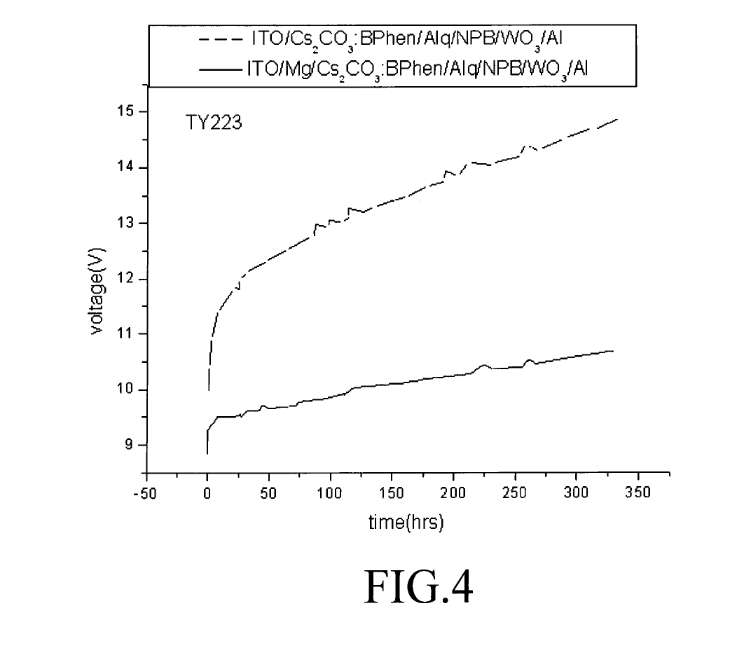

Referred to FIG. 2A and FIG. 2B, FIG. 2A illustrates the relation of voltage versus luminance and current intensity for the device of ITO/Cs2CO3:Bphen/Alq3/NPB/WO3/Al, and FIG. 2B illustrates the relation of voltage versus luminance and current intensity for the device of ITO/Mg/Cs2CO3:Bphen/Alq3/NPB/WO3/Al, in which Bphen is 4,7-diphenyl-1,10-phenanthroline, and NPB is N,N′-di(naphthalene-1-yl)-N, N′-diphthalbenzidine. With the comparison of FIG. 2A and FIG. 2B, the luminance an electricity of the device is not influenced in the existence of the electron-injection layer 202. Referred to FIG. 3, the addition of the electron-injection layer 202 may reduce the degraded luminance of the device. Referred to FIG. 4, the addition of the electron-injection layer 202 may enhance the stability of the device in operation.

Accordingly, an organic light emitting structure includes a substrate; a cathode and an anode corresponding each other on the substrate; a hole-transport layer between the cathode and the anode; an electron-transport layer between the hole-transport layer and the cathode; and an electron-injection layer between the cathode and the electron-transport layer. The electron-injection layer includes an alkaline-earth metal material.

Although the present invention has been explained in relation to its preferred embodiment, it is to be understood that other modifications and variation can be made without departing the spirit and scope of the invention as hereafter claimed.

What is claimed is:

1. An organic light emitting structure, comprising:
a substrate;
a cathode and an anode disposed on said substrate and said cathode facing said anode;
a hole-transport layer disposed between said cathode and said anode;
an electron-transport layer between said hole-transport layer and said cathode; and
an electron-injection layer between said cathode and said electron-transport layer, wherein said electron-injection layer includes an alkaline-earth metal material.

2. The organic light emitting structure according to claim 1, wherein said alkaline-earth metal material is Be, Ma, Ca, Sr, Ba, Ra or combination thereof.

3. The organic light emitting structure according to claim 1, wherein said cathode includes a transparent, opaque, reflective single layer or combination of indium tin oxide, indium zinc oxide, Au, Ag, Pt, Ni, Cr, Mo, Cu, Al, or Ca.

4. The organic light emitting structure according to claim 1, wherein said anode includes a transparent, opaque, reflective single layer or combination of Au, Pt, Li, Mg, Ca, Al or Ag, or indium tin oxide, indium zinc oxide, LiF/Au, Be/Al or Mg/Al.

5. The organic light emitting structure according to claim 1, wherein said electron-transport layer comprises an n-type doped layer.

6. The organic light emitting structure according to claim 1, wherein said hole-transport layer comprises a p-type doped layer.

7. The organic light emitting structure according to claim 1, further comprising an emitting layer between said electron-transport layer and hole-transport layer.

8. The organic light emitting structure according to claim 7, wherein said emitting layer comprises an organic emitting material or 8-hydroxyquinoline aluminum.

9. The organic light emitting structure according to claim 7, further comprising a hole-blocking layer between said emitting layer and said electron-transport layer.

10. The organic light emitting structure according to claim 1, further comprising a hole-injection between said hole-transport layer and said anode.

11. The organic light emitting structure according to claim 7, comprising an inverted organic light emitting structure.
